(19) United States
(12) Patent Application Publication
(10) Pub. No.: US 2012/0028034 A1
(43) Pub. Date: Feb. 2, 2012

(54) Laminates Containing Rigid, Plate-Shaped Minerals

(75) Inventor: Norbert Roesch, Gersthofen (DE)

(73) Assignee: CLARIANT FINANCE (BVI) LIMITED, Tortola (VG)

(21) Appl. No.: 13/259,400

(22) PCT Filed: Mar. 20, 2010
(86) PCT No.: PCT/EP10/01754

§ 371 Date: Oct. 13, 2011

(30) Foreign Application Priority Data
Mar. 24, 2009 (DE) 10 2009 014 638.5

(51) Int. Cl. B32B 5/16; B32B 37/00

(52) U.S. Cl. 428/329; 156/60

(57) ABSTRACT

The invention relates to a laminate containing in the overlay plate-shape, monocrystalline particles of aluminum oxide having a corundum crystalline lattice.

A multi-layered, thermosetting plastics material which is produced by compacting and adhering at least two layers of identical or different materials is referred to as a laminate. The properties of the individual materials can complement one another by being combined.

Conventional layer materials are approximately 0.5 to 1.2 mm thick and are generally mounted, during further processing, on a carrier material (for example HDF or chipboard) using a specific adhesive. The most common type of use for such laminate coatings is laminate flooring and kitchen worktops. However, laminates from 2 to 20 cm thick can also be produced without difficulty. Such products, which are referred to as ‘compact laminates’, are self-supporting with increasing thickness and are used, for example, in interior finishing, but are also used externally as façade or balcony cladding. Laminate has many positive properties: the surface is tight and resistant to impact and abrasion. It can be provided with different structures and is also resistant, in the short term, to high temperatures without sustaining damage. The surface is easy to maintain and clean, is heat resistant and light-fast, odorless and insensitive to alcohol and organic solvents as well as the effect of water vapor.

In order to produce a laminate sheet, a plurality of papers impregnated with resin are pressed together under pressure and temperature. Melamine-formaldehyde resins, phenol-formaldehyde resins, urea-formaldehyde resins and combinations of these materials are used as resins. in order to produce a high-quality, decorative layer material, as is used for example in laminate flooring, the following layers are used: the core consists of a plurality of papers impregnated with phenol resin, and above this lies the decorative layer which is impregnated with melamine resin. An ‘overlay’ is pressed on in the uppermost position and consists of two transparent papers impregnated with melamine resin, between which a corundum layer of coarse corundum (>20 μm) can be incorporated. It is also possible to use overlays filled with corundum. A counteracting layer is inserted on the underside and reduces warping of the finished material. The purpose of the coarse corundum is to protect the decorative layer against abrasion and it also provides the necessary stability. However, an increase in scratch resistance is rarely achieved.

With a multi-layered structure a sealing layer is generally also used and is not equipped with corundum in order to protect the pressed sheets and to avoid any roughness of the useable surface. In addition, coarse corundum would settle when the laminates are compressed. The sealing overlay is therefore subject to daily scratching when unprotected.

In WO 2008/101621 the sensitivity of the overlay to scratching is reduced by incorporating metal oxide nanoparticles. Nevertheless, it is desirable to considerably increase the insensitivity to scratching in the overlay of laminate boards.

This object could surprisingly be achieved by incorporating platelet-shaped, monocrystalline corundum in the overlay of a laminate board.

The invention therefore relates to laminates containing in the overlay plate-shaped, monocrystalline particles of aluminum oxide having a corundum crystalline lattice. Preferred particles which are used in accordance with the invention have a mean diameter in the range of 1 to 50 micrometers, preferably 2 to 20 micrometers, with a thickness of 50 to 500 nm. The aspect ratio (ratio of diameter to thickness) is between 1:10 and 1:100, preferably between 1:20 and 1:100, in particular between 1:30 and 1:100, most preferably between 1:50 and 1:100.

Each platelet is a corundum monocrystal which is completely transparent to visible light.

It may also be advantageous to mix the corundum platelets as claimed in the invention with nanoparticles of aluminum oxide, the fineness of which lies within the nm range, preferably <200 nm. Gaps between the platelets can be filled with the nanoparticles. The mixing ratio of nanocorundum to corundum platelets can be arbitrary.

Furthermore, it is possible to combine spherical coarse corundum (particle size of 10 to 100 μm), which is normally used to improve resistance to abrasion, with the corundum platelets as claimed in the invention.

Laminates with improved resistance to scratching and improved resistance to abrasion are obtained with this combination.

The coarse corundum, the platelet-shaped corundum or the combination thereof can be used in an amount of 1 to 20 g/m². Any mixing ratios can be used depending on the desired resistance to abrasion and scratching.

The production of plate-shaped aluminum oxide is known per se and is described in detail, for example, in Irish patent application IE 903320. In this case aluminum hydroxide is calcined in the presence of inorganic fluorides, such as LiF, NaF, KF or CaF₂ at temperatures between 900 and 1100° C.

Production can also be carried out in accordance with WO 2004/060804 A1, wherein aluminum hydroxide is calcined in a salt matrix, for example in NaCl or Na₂SO₄, which promotes anisotropic growth.

The platelet-shaped aluminum oxide used in accordance with the invention can be pure corundum or doped corundum. All metals which do not interfere with the formation of a platelet shape of the hexagonal crystalline lattice of the corundum phase, for example elements in main group II of the Periodic Table of the Chemical Elements, silicon, iron, cobalt, nickel, copper, zinc, zirconium, titanium, chromium, manganese and lanthanide elements can be considered for the doping process. The content of dopant is less than 10% by weight, in particular 0.0001 to 5% by weight.

In the embodiments below “platelet-shaped aluminum oxide” is understood to mean both pure and doped corundum in platelet form.

The invention also relates to a method for producing the laminates as claimed in the invention, wherein platelet-shaped aluminum oxide, which comprises a corundum crystalline lattice, is mixed with an impregnating resin solution, a paper or a textile woven fabric, preferably a decorative paper, is impregnated in the top-coat overlay with this mixture and the impregnated paper or textile woven fabric is applied to a carrier plate in a hot press.

The amount of platelet-shaped aluminum oxide, based on solid impregnating resin, is expediently 1 to 10% by weight. With conventional layer thicknesses of the overlay layer of 10 to 50 μm, this corresponds to a mineral content of 1 to 20 g/m².

Formaldehyde-melamine resins, formaldehyde-urea resins, formaldehyde-phenol resins and combinations of these resins are preferably used as impregnating resins. The resins are normally dissolved in water and may contain further conventional additives, such as hardeners and leveling agents.

The paper or textile woven fabric is expediently passed through a bath containing an impregnating resin solution one or more times with intermediate drying (base-coat overlay), before the top-coat overlay is impregnated in accordance with the invention. In order to improve the resistance to abrasion a spherical coarse corundum can be added to this impregnating resin solution, expediently in an amount of 1 to 10% by weight, based on solid impregnating resin. The top-coat can be impregnated by dipping in a further bath which contains the platelet-shaped aluminum oxide particles as claimed in the invention, or by spraying with an appropriate liquid mixture. It is also possible to impregnate the paper or textile woven fabric one or more times merely with the liquor which contains the platelet-shaped aluminum oxide particles as claimed in the invention.

The hot press generally functions at a temperature between 100 and 180° C. and a pressure between 80 and 200 bar.

The impregnating resin solution generally has a resin concentration between 30 and 70% by weight, preferably between 40 and 60% by weight.

In an alternative approach an ‘overlay paper’ is used which is already impregnated with resin and contains the platelet-shaped aluminum oxide particles as claimed in the invention and optionally spherical coarse corundum in the paper mass. This overlay paper is then laid on the decorative paper and is likewise applied to the carrier plate in a hot press.

It is also conceivable to use, as overlay, UV varnishes which contain the platelet-shaped corundum.

The laminates as claimed in the invention can also contain further additives, as are conventional in varnishing techniques, for example reactive thinning agents, solvents and co-solvents, waxes, matting agents, lubricants, antifoaming agents, aspirators, leveling agents, thixotropic agents, thickening agents, inorganic and organic pigments, fillers, adhesion promoters, UV stabilizers, HALS compounds, radical scavengers, antistatic agents, wetting agents and dispersing agents and/or the catalysts, co-catalysts, initiators, radical formers, photoinitiators and photosensitizers which are necessary depending on the type of curing. Polyethylene glycol and other water retention agents, PE waxes, PTFE waxes, PP waxes, amide waxes, FT paraffins, montan waxes, grafted waxes, natural waxes, macro- and microcrystalline paraffins, polar polyolefin waxes, sorbitan esters, polyamides, polyolefins, PTFE, wetting agents or silicates are also possible further additives.

In the examples below the percentages are percentages by weight.

### EXAMPLE 1

Platelet-shaped corundum particles of 1 to 30 micrometers in diameter and with a thickness of 50 to 200 nm (aspect ratio of approximately 1:90) are produced similarly to Example 5 of WO 2004/060804 A1.

The corundum platelets were mixed with an aqueous impregnating resin (8% corundum platelets based on solid Kauramin® 773, BASF, approximately 50% resin solution) together with hardeners and leveling agents, and the mixture was used to coat printed black decorative paper. Said paper was impregnated twice with this liquor and in each case pre-condensed in a drying chamber at 120° C. Once the impregnation had dried, the decorative paper was laminated on carrier plates (40×40 cm, HD carrier plates 5 mm thick) in a hot press at 160° C. and a pressure of 200 bar. The pressing lasted for 4 min.

### Comparative Example 1 (Without Mineral Addition)

An approach was adopted as in Example 1, but without corundum platelets in the impregnating resin.

### Comparative Example 2 (Nanocorundum)

Instead of platelet-shaped corundum, nanocorundum with a d₉₀ of 120 nm, produced in accordance with DE-A-102007008468, was incorporated into the impregnating resin mentioned in Example 1 in an amount of 8%. Production of the decorative paper and lamination were likewise carried out as in Example 1.

### Comparative Example 3 (Coarse Corundum)

Instead of plate-shaped corundum, spherical coarse corundum with a d₉₀ of 80 μm was incorporated into the impregnating resin mentioned in Example 1 in an amount of 8%. The liquor provided with coarse corundum was used only in the first impregnation. The second impregnation was carried out with Kauramin without corundum. Production of the decorative paper and lamination were likewise carried out as in Example 1.

The scratch resistance of each of the finished laminate pieces was examined using a scratch tester. Scotch-brite pad no. 96 was used with a loading force of 5 N (0.5 kg weight). The pad was moved in a linear manner with 200 strokes. The reduction in gloss, caused by the scratcher, was measured after every 50 strokes using the MICRO-TRI-GLOSS μ gloss measuring device (BYK Gardner).

Owing to their high transparency, the corundum particles do not cause any impairment of the visual properties.

The table shows the corresponding residual gloss after 200 strokes (scratchings):

| | Example: | | | |
|---|---|---|---|---|
| | Example 1 | Comp. ex. 1 | Comp. ex. 2 | Comp. ex. 3 |
| Morphology: | platelets | without | nanoparticles | coarse |
| | | mineral | | corundum |
| rel. residual | 90 | 40 | 72 | 62 |
| gloss [%]: | | | | |

The resistance to scratching could be significantly improved by the corundum platelets as claimed in the invention.

1. A laminate containing an overlay, wherein the overlay comprises plate-shaped, monocrystalline particles of aluminum oxide having a corundum crystalline lattice, wherein the particles of aluminum oxide have a mean diameter in the range of 1 to 50 micrometers and a thickness of 50 to 500 nm.

2. The laminate as claimed in claim 1, wherein the particles of aluminum oxide have an aspect ratio between 1:10 and 1:100.

3. The laminate as claimed in claim 2, wherein the aspect ratio of the particles of aluminum oxide is between 1:50 and 1:100.

4. The laminate as claimed in claim 1, wherein the particles of aluminum oxide are corundum doped with metals.

5. The laminate as claimed in claim 1, wherein the particles of aluminum oxide are present in the overlay in an amount of 1 to 20 g/m².

6. The laminate as claimed in claim 1, wherein the plate-shaped particles of aluminum oxide are combined with spherical coarse corundum having a particle size of 10 to 100 μm.

7. A method for producing a laminate having a top-coat overlay as claimed in claim 1, comprising the steps of mixing the plate-shaped aluminum oxide, wherein the plate-shaped aluminum oxide comprises a corundum crystalline lattice, with an impregnating resin solution, a paper or textile woven fabric to form a mixture, impregnating the top-coat overlay with the mixture, and applying the impregnated paper or textile woven fabric to a carrier plate in a hot press.

8. The method as claimed in claim 7, further comprising passing the paper or textile woven fabric through a bath containing the impregnating resin solution one or more times with intermediate drying and thereafter impregnating the top-coat overlay.

9. The method as claimed in claim 7, wherein the top-coat overlay is impregnated by dipping in a bath containing the plate-shaped aluminum oxide particles, or by spraying with a liquid mixture of the plate-shaped aluminum oxide particles and the impregnating resin solution.

10. The method as claimed in claim 7, wherein the top-coat overlay is impregnated with an overlay paper, wherein the overlay paper is already impregnated with the resin solution and contains the plate-shaped aluminum oxide particles and optionally spherical coarse corundum in the paper mass, by laying the overlay paper on the paper or textile woven fabric, and applying the paper or textile woven fabric to the carrier plate in a hot press.

11. The method as claimed in claim 7, wherein the textile or woven fabric is decorative paper.
